(19) United States
(12) Patent Application Publication
(10) Pub. No.: US 2019/0167003 A1
(43) Pub. Date: Jun. 6, 2019

(54) NOVEL DOOR TYPE OF KITCHEN CABINET

(71) Applicant: ZBOM HOME COLLECTION CO., LTD., Anhui (CN)

(72) Inventors: Qiang Xia, Anhui (CN); Anyong Wang, Anhui (CN); Dan Wang, Anhui (CN)

(73) Assignee: ZBOM HOME COLLECTION CO., LTD., Anhui (CN)

(21) Appl. No.: 16/321,819

(22) PCT Filed: May 25, 2018
(86) PCT No.: PCT/CN2018/088317

§ 371 Date: Jan. 29, 2019

(30) Foreign Application Priority Data
May 27, 2017 (CN) 201720610761.8

(51) Int. Cl. A47B 95/02; E06B 3/30; E06B 3/70

(52) U.S. Cl. CPC A47B 95/02; E06B 3/70; E06B 3/30

(57) ABSTRACT

A door type of kitchen cabinet includes a door panel and an edge-sealing handle mounted on an upper end of the door panel. The edge-sealing handle includes an edge-sealing plate located above a top portion of the door panel, a buckle plate disposed above a front end of the edge-sealing plate, a decorative plate disposed below the front end of the edge-sealing plate, a closing strip disposed at a bottom portion of the decorative plate, and a fixing leg disposed under a middle section of the edge-sealing plate and embedded in the top portion of the door panel. The top portion of the door panel is provided with a mounting groove corresponding to the fixing leg.

### BACKGROUND OF THE DISCLOSURE

### Field of the Disclosure

The utility model relates to the technical field of kitchen cabinets, in particular to a novel door type of kitchen cabinet.

### Description of Related Art

Conventional door type with edge-sealing handle is typically designed in a manner that a metal part is completely disposed on an upper part of the door, which makes it difficult to achieve the design of exposing a large area of metal surface. It is difficult to make the metal and a door material to fit accurately in terms of the structure, and the firmness of connection between the metal and the door material is not sufficient.

### SUMMARY OF THE DISCLOSURE

### Technical Problem

The purpose of the present utility model is to provide a novel door type of kitchen cabinet, which is capable of solving the deficiencies in the related art, and not only achieves exposure of large area of metal surface, but also effectively improves matching accuracy and rigid firmness of connection between the metal handle and the door panel.

### Technical Solution

In order to achieve the above purpose, the present utility model adopts following technical solutions.

A novel door type of kitchen cabinet includes a door panel and an edge-sealing handle mounted on an upper end of the door panel. The edge-sealing handle includes an edge-sealing plate located above a top portion of the door panel, a buckle plate disposed above a front end of the edge-sealing plate, and a decorative plate disposed under the front end of the edge-sealing plate, a closing strip at a bottom portion of the decorative plate, and a fixing leg disposed under a middle section of the edge-sealing plate and embedded in the top portion of the door panel. The top portion of the door panel is provided with a mounting groove corresponding to the fixing leg.

Further, the edge-sealing handle is made of a metal material.

Further, a front side of the upper end of the door panel is provided with a mounting surface corresponding to the decorative plate. A height of the mounting surface is equal to a height of the decorative plate.

Further, the fixing leg includes a fixing plate and a barb structure disposed on front and rear side walls of the fixing plate.

Further, a depth of the mounting groove is greater than a height of the fixing leg.

### Advantageous Effect

Based on the above technical solution, it can be obtained that the disclosure optimizes the structure to improve the deficiency in configuration of conventional door type with edge-sealing handle by increasing one surface as the mounting surface to two surfaces which restrain the degree of freedom of each other, thereby greatly improving the stability of the door panel and the edge-sealing handle structure, so that the large area of metal surface can be exposed, which facilitates to enhance the production quality and production efficiency of mass production.

### BRIEF DESCRIPTION OF THE DRAWINGS

FIG. 1 is a schematic view of a structure of the present utility model.

FIG. 2 is a side view of the present utility model.

FIG. 3 is a schematic structural view of a door panel.

FIG. 4 is a schematic structural view of an edge-sealing handle.

Wherein:

1. edge-sealing handle; 11. edge-sealing plate; 12. buckle plate; 13. decorative plate; 14. closing strip; 15. fixing leg; 16. barb structure; 2. door panel; 21. mounting groove; 22. mounting surface.

### DESCRIPTION OF EMBODIMENTS

### Optimal Embodiment of the Disclosure

The present utility model will be further described with reference to the embodiments and the accompanying drawings.

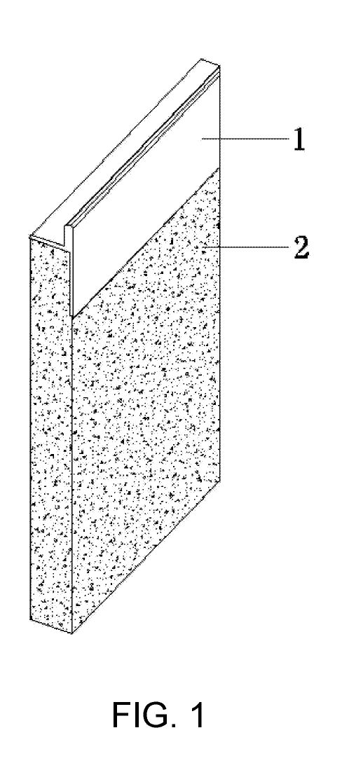

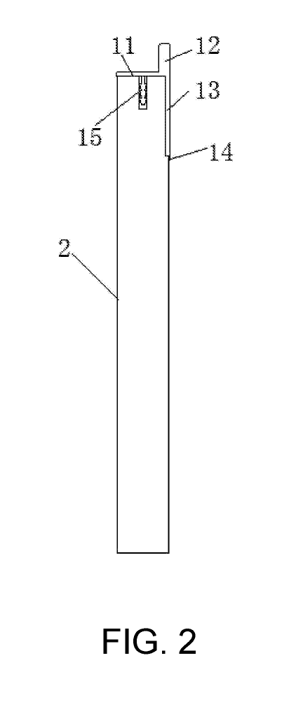

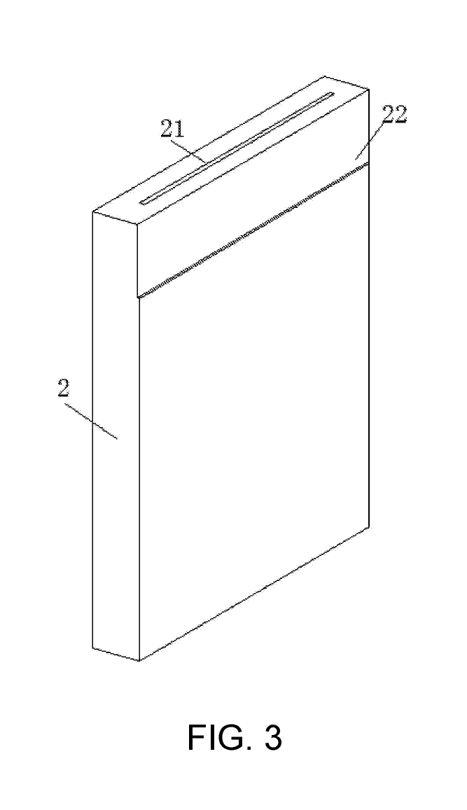

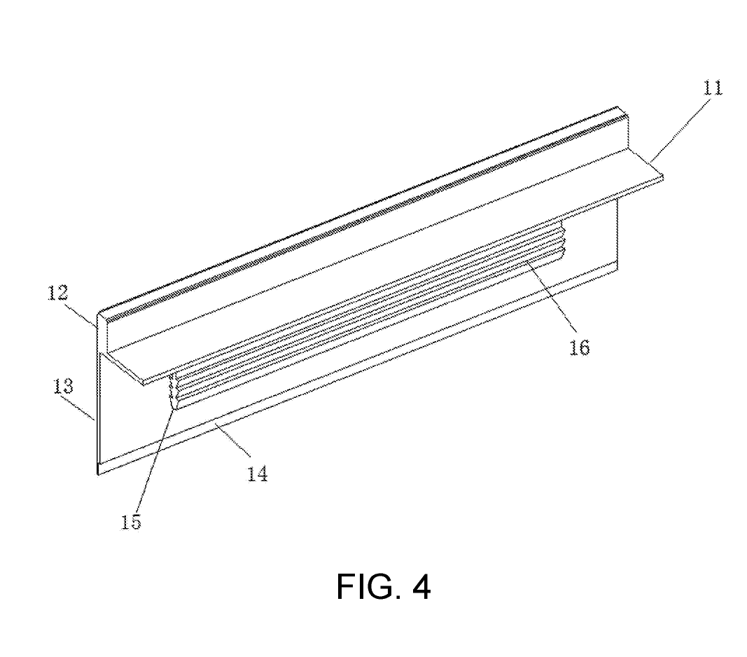

A novel door type of kitchen cabinet as shown in FIG. 1-FIG. 4 includes a door panel 2 and an edge-sealing handle 1 mounted on an upper end of the door panel 2. The edge-sealing 1 is adhered to the door panel 2 through an adhesive. The edge-sealing handle 1 includes an edge-sealing plate 11 located above a top portion of the door panel 2, a buckle plate 12 disposed above a front end of the edge-sealing plate 11, a decorative plate 13 disposed under the front end of the edge-sealing plate 11, a closing strip 14 disposed at a bottom portion of the decorative plate 13, and a fixing leg 15 disposed under a middle section of the edge-sealing plate 11 and embedded in the top portion of the door panel 1. The top portion of the door panel 2 is provided with a mounting groove 21 corresponding to the fixing leg 15. The edge-sealing plate is configured for sealing the edge on the top portion of the door panel. The buckle plate is configured to open a kitchen cabinet door. The decorative plate is arranged on a front side of the upper end of the door panel, and provides protection for the upper end of the door panel which is often in contact with a user's hand. The closing strip is configured for ensuring the firmness of the connection between the decorative plate and a mounting surface, and prevents dust and moisture from entering into a gap between the decorative plate and a bottom portion of the mounting surface, thereby further ensuring the firmness of the connection between the two.

Further, the edge-sealing handle 1 is made of metal.

Further, the front side of the upper end of the door panel 2 is provided with a mounting surface 22 corresponding to the decorative plate, and a height of the mounting surface 22 is equal to a height of the decorative plate 13.

Further, the fixing leg 15 includes a fixing plate and a barb structure 16 disposed on front and rear side walls of the fixing plate. The fixing leg 15 is embedded in the mounting groove 21. On the basis that the fixing leg and the mounting groove are connected through the adhesive, the barb structure further ensures the firmness of the connection between the fixing leg and the mounting groove.

Further, a depth of the mounting groove 21 is greater than a height of the fixing leg 15.

The configuration process of the utility model is:

The edge-sealing handle 1 is formed by hot-drawing an aluminum material and cut to a specified length, wherein both ends of the fixing leg 15 need to be cut by 5 centimeters and should be ensured that a joint surface of the edge-sealing plate 11 and the fixing leg 15 is smooth with no burrs.

The door panel 2 needs to leave a mounting surface 22 by CNC milling, and its milling depth is equal to a thickness of the decorative plate 13 in the edge-sealing handle 1. At the same time, a mounting groove 21 is formed on the top portion of the door panel by using a sawing machine. The depth of the mounting groove 21 is greater than the depth of the fixing leg 15 in the edge-sealing handle 1, and a width of the mounting groove 21 is larger than a width of the fixing leg 15, so as to ensure that the fixing leg has a certain degree of freedom to be adjusted in the mounting groove.

First, a certain amount of the adhesive (glass glue or wood glue) is applied to an inner wall of the mounting groove 21 of the door panel 2 and the mounting surface 22. Then, the fixing leg 15 is inserted into the mounting groove 21, and the fixing leg is fixed in the fixing groove through the adhesive. Meanwhile, the rear side wall of the decorative plate is closely adhered to a longitudinal surface of an L-shaped mounting surface, and a bottom surface of the decorative plate is closely adhered to a lateral surface of the L-shaped mounting surface. In this process, it should be ensured that the configuration is performed properly and there is no hollow sounding and warp. Finally, the closing strip 14 of the edge-sealing handle 1 completely covers a lower port of the mounting surface 22 of the door panel 2, thereby achieving the function of closing the opening. The mounted door type is tightened by a clamp, and is waited for 24 hours for the glue to become dry.

The embodiments described above are only intended to describe the preferred embodiments of the present disclosure, and are not intended to limit the scope of the present disclosure. Without departing from the spirit of the present disclosure, various modifications and improvements made by those skilled in the art to the technical solutions of the present disclosure are regarded as falling within the scope as defined in the appended claims.

### Embodiments of the Disclosure

A novel door type of kitchen cabinet as shown in FIG. 1-FIG. 4 includes a door panel 2 and an edge-sealing handle 1 mounted on an upper end of the door panel 2. The edge-sealing 1 is adhered to the door panel 2 through an adhesive. The edge-sealing handle 1 includes an edge-sealing plate 11 located above a top portion of the door panel 2, a buckle plate 12 disposed above a front end of the edge-sealing plate 11, a decorative plate 13 disposed under a front end of the edge-sealing plate 11, a closing strip 14 disposed at a bottom portion of the decorative plate 13, and a fixing leg 15 disposed under a middle section of the edge-sealing plate 11 and embedded in the top portion of the door panel 1. The top portion of the door panel 2 is provided with a mounting groove 21 corresponding to the fixing leg 15. The edge-sealing plate is configured for sealing the edge on the top portion of the door panel. The buckle plate is configured to open a kitchen cabinet door. The decorative plate is arranged on a front side of the upper end of the door panel, and provides protection for the upper end of the door panel which is often in contact with a user's hand. The closing strip is configured for ensuring the firmness of the connection between the decorative plate and a mounting surface, and prevents dust and moisture from entering into a gap between the decorative plate and a bottom portion of the mounting surface, thereby further ensuring the firmness of the connection between the two.

Further, the edge-sealing handle 1 is made of metal.

Further, the front side of the upper end of the door panel 2 is provided with a mounting surface 22 corresponding to the decorative plate, and a height of the mounting surface 22 is equal to a height of the decorative plate 13.

Further, the fixing leg 15 includes a fixing plate and a barb structure 16 disposed on front and rear side walls of the fixing plate. The fixing leg 15 is embedded in the mounting groove 21. On the basis that the fixing leg and the mounting groove are connected through the adhesive, the barb structure further ensures the firmness of the connection between the fixing leg and the mounting groove.

Further, a depth of the mounting groove 21 is greater than a height of the fixing leg 15.

The configuration process of the utility model is:

The edge-sealing handle 1 is formed by hot-drawing an aluminum material and cut to a specified length, wherein both ends of the fixing leg 15 need to be cut by 5 centimeters and should be ensured that a joint surface of the edge-sealing plate 11 and the fixing leg 15 is smooth with no burrs.

The door panel 2 needs to leave a mounting surface 22 by CNC milling, and its milling depth is equal to a thickness of the decorative plate 13 in the edge-sealing handle 1. At the same time, a mounting groove 21 is formed on the top portion of the door panel by using a sawing machine. The depth of the mounting groove 21 is greater than the depth of the fixing leg 15 in the edge-sealing handle 1, and a width of the mounting groove 21 is larger than a width of the fixing leg 15, so as to ensure that the fixing leg has a certain degree of freedom to be adjusted in the mounting groove.

First, a certain amount of the adhesive (glass glue or wood glue) is applied to an inner wall of the mounting groove 21 of the door panel 2 and the mounting surface 22. Then, the fixing leg 15 is inserted into the mounting groove 21, and the fixing leg is fixed in the fixing groove through the adhesive. Meanwhile, the rear side wall of the decorative plate is closely adhered to a longitudinal surface of an L-shaped mounting surface, and a bottom surface of the decorative plate is closely adhered to a lateral surface of the L-shaped mounting surface. In this process, it should be ensured that the configuration is performed properly and there is no hollow sounding and warp. Finally, the closing strip 14 of the edge-sealing handle 1 completely covers a lower port of the mounting surface 22 of the door panel 2, thereby achieving the function of closing the opening. The mounted door type is tightened by a clamp, and is waited for 24 hours for the glue to become dry.

### INDUSTRIAL APPLICABILITY

Based on the above technical solution, it can be obtained that the disclosure optimizes the structure to improve the deficiency in configuration of conventional door type with edge-sealing handle by increasing one surface as the mounting surface to two surfaces which restrain the degree of freedom of each other, thereby greatly improving the stability of the door panel and the edge-sealing handle structure, so that the large area of metal surface can be exposed, which facilitates to enhance the production quality and production efficiency of mass production.

1. A door type of kitchen cabinet, comprising: a door panel and an edge-sealing handle mounted on an upper end of the door panel; the edge-sealing handle comprises an edge-sealing plate located above a top portion of the door panel, a buckle plate disposed above a front end of the edge-sealing plate, a decorative plate disposed below the front end of the edge-sealing plate, a closing strip disposed at a bottom portion of the decorative plate, and a fixing leg disposed under a middle section of the edge-sealing plate and embedded in the top portion of the door panel; the top portion of the door panel is provided with a fixing groove corresponding to the fixing leg.

2. The door type of kitchen cabinet according to claim 1, wherein the edge-sealing handle is made of metal.

3. The door type of kitchen cabinet according to claim 1, wherein a front side of the upper end of the door panel is provided with a mounting surface corresponding to the decorative plate, and a height of the mounting surface is equal to that of the decorative plate.

4. The door type of kitchen cabinet according to claim 1, wherein the fixing leg comprises a fixing plate and a barb structure disposed on front and rear side walls of the fixing plate.

5. The door type of kitchen cabinet according to claim 1, wherein the mounting groove has a depth greater than a height of the fixing leg.
